(19) United States
(12) Patent Application Publication
(10) Pub. No.: US 2015/0176527 A1
(43) Pub. Date: Jun. 25, 2015

(54) AIRCRAFT GAS TURBINE COMPRISING AN ENGINE COWLING WITH A THRUST-REVERSER DEVICE

(71) Applicants: Rolls-Royce Deutschland Ltd & Co KG, Blankenfelde-Mahlow (DE); Liebherr-Aerospace Lindenberg GmbH, Lindenberg (DE)

(72) Inventors: Predrag TODOROVIC, Berlin (DE); Uwe SCHUMANN, Tettnang (DE); Frank MUELLER, Lindenberg/Allgaeu (DE); Dirk METZLER-STOERMER, Oberreute (DE)

(21) Appl. No.: 14/575,597

(22) Filed: Dec. 18, 2014

(30) Foreign Application Priority Data
Dec. 19, 2013 (DE) 10 2013 226 770.3

(51) Int. Cl. F02K 1/72; B64D 29/06; B64D 33/04

(52) U.S. Cl. CPC F02K 1/72; B64D 33/04; B64D 29/06

(57) ABSTRACT

The present invention relates to an aircraft gas turbine comprising an engine cowling that has a rear area, with respect to the direction of the flow, which has a thrust-reverser device, wherein the rear area is embodied in such a manner as to be translatable in the axial direction, characterized in that the rear area is mounted in a translatable manner at two rails that are arranged in parallel to each other, and that it comprises a gear rack that is mounted at each rail, respectively, with the gear rack being in mesh with a respective cog wheel, which is coupled to a common motor via a gear unit, respectively.

The invention relates to an aircraft gas turbine comprising an engine cowling with a thrust-reverser device according to the preamble of claim 1.

In particular, the invention relates to an aircraft gas turbine with an engine cowling which has a rear area, with respect to the direction of the current, that is provided with a thrust-reverser device, wherein the rear area is designed so as to be translatable for the purpose of actuating the thrust-reverser device in the axial direction with respect to the machine axis of the aircraft gas turbine.

Various embodiments of thrust-reverser devices are known from the state of the art. Thus, in US 2010/0139242 A1, for example, a translatable rear area of an engine cowling (trans cowl) is shown, which is shifted by means of multiple hydraulic actuating elements. Here, piston-cylinder units as well as gear units are provided so that the multiple actuating devices may be moved in a steady manlier. As this is done, particularly a synchronization around the circumference of the engine cowling is necessary in order to monitor and synchronize the steady displacement of the rear area of the engine cowling or of its individual components. This is necessary particularly for the reason that individual actuating devices may fail or may not be working reliably due to malfunctions. The multiple actuating devices are coupled to slide mechanisms, respectively, inside which the individual structural elements or components are displaced. This results in considerable friction and creates the danger of the entire assembly tilting and jamming, since the actuators are not placed in the same line as the shifting mechanism. This poses a considerable problem, especially when there are high temperature differences and unfavourable operating conditions, and also when vibrations occur. In order to ensure a steady translation of the individual components, the structures known from the state of the art not only have multiple actuating devices, but also comprise varied kinds of slide rail systems, which are in particular arranged so as to be distributed at the top side and the bottom side of the engine cowling and/or around its circumference. On the whole, this results in a high expenditure with respect to the necessary devices, which involves high expenditures particularly with regard to monitoring the different structural elements and components, and which is cost-intensive and time-consuming with respect to manufacturing as well as to maintenance.

The invention is based on the objective to create an aircraft gas turbine comprising an engine cowling with a thrust-reverser device, in which the disadvantages of the state of the art are avoided and in which a high degree of operational safety is achieved, while also allowing for a simple assembly and easy, cost-effective manufacturability.

According to the invention, the problem is solved by the combination of features of claim 1, with the subclaims showing further advantageous embodiments of the invention.

Thus, it is provided that the rear area of the engine cowling is mounted in a translatable manner on two rails that are parallel to each other. Thus, what is present here is a (telescopic) rail configuration, wherein the rail elements that are arranged at the rear area of the engine cowling are provided with a gear rack, respectively. Thus, the solution according to the invention provides two gear racks that are spaced apart from each other and that slide on the two rails that are arranged in parallel to each other and thus facilitate an axial translation of the rear area of the engine cowling. With the gear racks. one cog wheel or sprockets is meshed, respectively, in order to move the gear rack relative to the rail. The cog wheel is coupled with a common motor via one gear unit, respectively (rack & pinion principle).

Thus, through the embodiment according to the invention, only one single actuating element, namely the common motor, is necessary in order to displace the entire rear area of the engine cowling. Since the motor is in mesh with both gear units and since these two gear units are in mesh with the respective gear rack via the cog wheel, a synchronized and steady movement of the two gear racks inside the rails is achieved. Thus, the driving force acts in the same line as the frictional force of the rail configuration, In this way, no jamming can occur, but rather a reliable and steady translation of the rear area of the engine cowling is achieved.

In the light of past experience, synchronization measures, such as are known from the state of the art, can be dispensed with due to the fact that a steady translation of the entire rear engine cowling by the one common motor is ensured at all times.

In addition to a substantial increase in operational safety, a more simple embodiment is also provided since in total less structural components are necessary. Thus, the total weight as well as the cost of the engine cowling is reduced.

According to the invention, the gear rack is mounted in a longitudinally translatable manner inside a slipway inside the rail. Preferably, the mounting is carried out in the form of a friction bearing. However, it is also possible to provide a roller bearing, or the like.

According to the invention, the rear area of the engine cowling is formed in a substantially ring-like shape, with the motor preferably being positioned in the upper area of the engine cowling. This is advantageous especially with regard to the forces that are acting on the engine cowling, since the motor can be arranged on a pylon in the area of the engine's suspension.

It is especially advantageous when the two rails are spaced apart around the width of the pylon which is supporting the engine. Thus, the engine cowling can be embodied in a substantially ring-like shape, except for the area of the pylon. In this way, a stiff structure becomes possible, in which additional braces or the like can be dispensed with. This, too, results in a substantial reduction of the total weight.

The gear unit that is used according to the invention is preferably embodied as an angular gear in order to allow for a dimensioning of the motor that is advantageous with regard to the operation. In this way, optimization with respect to the occurring torques is possible. Being arranged in an angle, the cogs of the gear rack mechanism bring several cogs in contact with each other simultaneously, which results in an optimized level of vibration and in low noise.

According to the invention, the motor is embodied as a hydraulic motor or as an electric motor. It can easily be dimensioned in such a way that, in addition to the mere translation of the rear area of the engine cowling, other elements of a thrust-reverser device, for example cascades or doors or the like, can be actuated, as well.

In the following, the invention is descried in connection with the drawings by using exemplary embodiments. In the Figures:

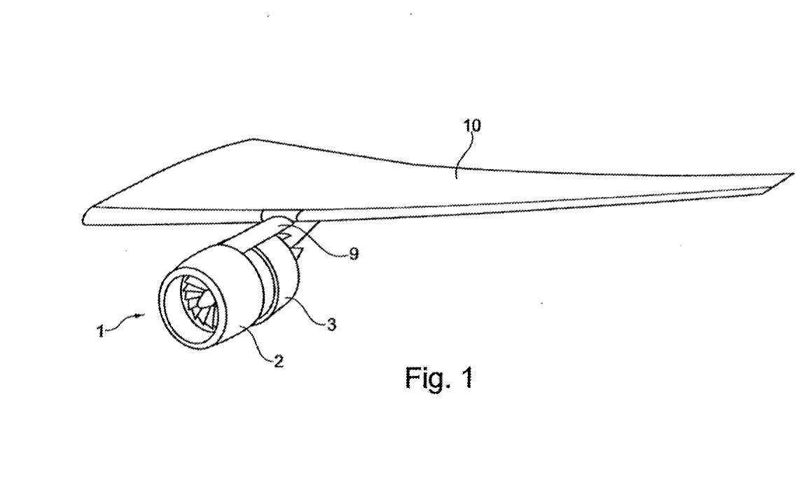

FIG. 1 shows schematic representation of an aircraft gas turbine at a wing of an airplane.

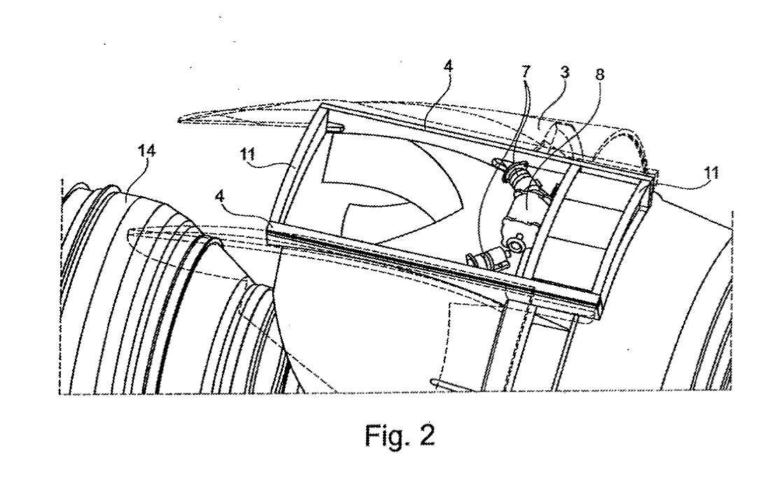

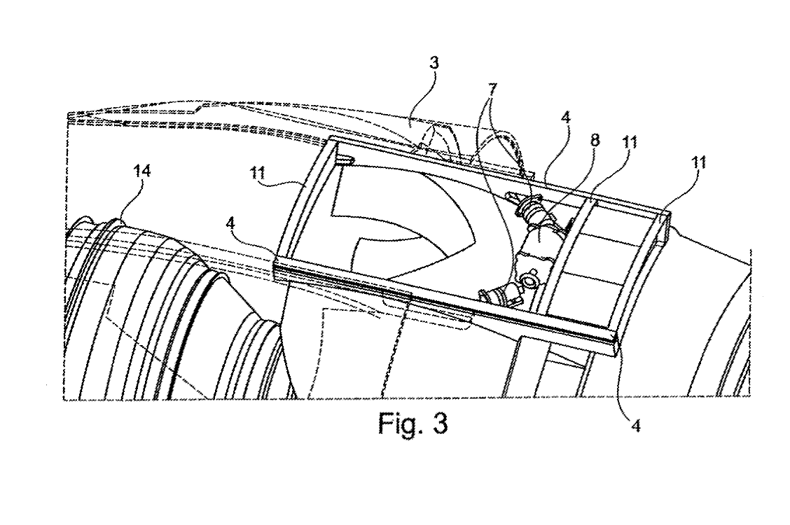

FIGS. 2 and 3 show schematic top views of the embodiment according to the invention in the closed as well as in the open state of the rear area of the engine cowling, and

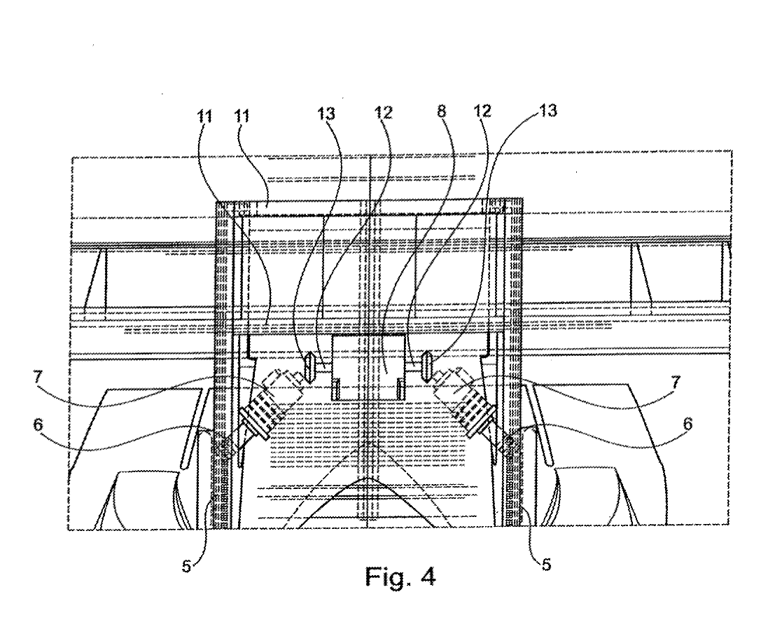

FIG. 4 shows a simplified top view of the motor and the associated gear units,

FIG. 1 shows a simplified schematic representation of an aircraft gas turbine 1. It comprises an engine cowling 2, which has a rear area 3 that is translatable in the axial direction, with respect to the machine axis. The aircraft gas turbine 1 is attached to a wing 10 of an aircraft by means of a pylon 9, as known from the state of the art.

FIGS. 2 and 3 show a simplified representation of an exemplary embodiment of the invention, which comprises two parallel rails 4 that are spaced apart from each other, being mounted and spaced apart with regard to each other by means of cross braces 11. With view to rendering the representation in a simplified manner, the mounting of the rails 4 at the aircraft gas turbine 1 itself has been omitted in the drawing.

FIG. 4 shows a simplified top view of he arrangement which is shown in FIGS. 2 and 3. Here, a centric common motor 8 is shown as having lateral output shafts that are in mesh with two gear units 7 via bevel gear wheels 13. The gear units 7 are in turn connected to one cog wheel 6, respectively, which is respectively in mesh with a gear rack 5.

The two gear racks 5 are guided in a sliding fashion inside the rails 4 and are connected to the rear area 3 of the engine cowling 2.

FIGS. 2 and 3 show a closed state of the rear area 3 of the engine cowling 2 (FIG. 2) as well as an open state (FIG. 3). The engine cowling 2, which is only partially shown with view to simplification, is embodied in the form of a ring which is closed, except for the recess that serves for mounting at the rails 4.

### LIST OF REFERENCES

1 aircraft gas turbine
2 engine cowling
3 rear area
4 rail
5 gear rack
6 cog wheel
7 gear unit
8 motor
9 pylon
10 wing
11 cross brace
12 drive shaft
13 bevel gear wheel
14 core engine

1. Aircraft gas turbine comprising an engine cowling which has a rear area, with respect to the direction of the current, that has a thrust-reverser device, wherein the rear area is embodied in such a way as to be translatable in the axial direction, characterized in that the rear area is mounted in a translatable manner on two rails that are arranged in parallel to each other and that it comprises respectively one gear rack mounted on each rail, with the gear rack being in mesh with one cog wheel, respectively, which is respectively coupled to a common motor via a gear unit

2. Aircraft gas turbine according to claim 1, wherein the gear rack is mounted in a longitudinally translatable manner inside a slipway of the rail.

3. Aircraft gas turbine according to claim 1, wherein the motor is arranged at the upper area of the engine cowling.

4. Aircraft gas turbine according to claim 1, wherein the rear area (3) of the engine cowling is formed in a substantially ring-like shape.

5. Aircraft gas turbine according to claim 1, wherein the rails are spaced apart substantially around the width of a pylon which supports the engine.

6. Aircraft gas turbine according to claim 1, wherein the gear unit is embodied as an angular gear.

7. Aircraft gas turbine according to claim 1, wherein the motor (8) is embodied as a hydraulic motor or as an electric motor.

8. Aircraft gas turbine according to claim 1, wherein the actuating force of the gear rack and the cog wheel is oriented in the same effective direction as the rails.
